(19) United States
(12) Patent Application Publication
(10) Pub. No.: US 2014/0280391 A1
(43) Pub. Date: Sep. 18, 2014

(54) INFORMATION PROCESSING DEVICE, STORAGE MEDIUM, AND FILE MANAGEMENT SYSTEM

(71) Applicant: FUJI XEROX CO., LTD., TOKYO (JP)

(72) Inventor: Kohshiro INOMATA, Kanagawa (JP)

(73) Assignee: FUJI XEROX CO., LTD., TOKYO (JP)

(21) Appl. No.: 14/021,230

(22) Filed: Sep. 9, 2013

(30) Foreign Application Priority Data
Mar. 15, 2013 (JP) 2013-053080

(51) Int. Cl. G06F 17/30

(52) U.S. Cl. CPC G06F 17/3007
USPC 707/821

(57) ABSTRACT

An information processing device includes an acceptance unit, a specification unit, and a naming unit. The acceptance unit accepts a name of a file. The specification unit specifies a maximum value of serial numbers added to the name of the file accepted by the acceptance unit, among files managed by a file management unit that manages the files. The naming unit gives a serial-numbered file name to the file accepted by the acceptance unit by adding a number that follows the maximum value specified by the specification unit to the name of the file.

### CROSS-REFERENCE TO RELATED APPLICATIONS

This application is based on and claims priority under 35 USC 119 from Japanese Patent Application No. 2013-053080 filed Mar. 15, 2013.

### BACKGROUND

### Technical Field

The present invention relates to an information processing device, a storage medium, and a file management system.

### SUMMARY

According to an aspect of the present invention, there is provided an information processing device including: an acceptance unit that accepts a name of a file; a specification unit that specifies a maximum value of serial numbers added to the name of the file accepted by the acceptance unit, among files managed by a file management unit that manages the files; and a naming unit that gives a serial-numbered file name to the file accepted by the acceptance unit by adding a number that follows the maximum value specified by the specification unit to the name of the file.

### BRIEF DESCRIPTION OF THE DRAWINGS

Exemplary embodiments of the present invention will be described in detail based on the following figures, wherein:

FIG. 1 shows the overall configuration and the block configuration of a file management system according to a first exemplary embodiment of the present invention;

FIG. 2 shows the hardware configuration of an image forming apparatus according to the first exemplary embodiment;

FIG. 3 is a flowchart showing a file registration process according to the first exemplary embodiment;

FIG. 4 is a flowchart showing a serial-numbered file name changing process shown in FIG. 3;

FIG. 5 shows the overall configuration and the block configuration of a file management system according to a second exemplary embodiment of the present invention; and

FIG. 6 is a flowchart showing a file registration process according to the second exemplary embodiment.

### DETAILED DESCRIPTION

Exemplary embodiments of the present invention will be described below with reference to the drawings.

### First Embodiment

FIG. 1 shows the overall configuration of a file management system according to an exemplary embodiment and the block configuration of an image forming apparatus 10 and a file management server 20 included in the file management system. The image forming apparatus 10 according to the exemplary embodiment corresponds to the information processing device according to the present invention. The image forming apparatuses 10 included in the file management system according to the exemplary embodiment may be basically the same in configuration as each other. Thus, the block configuration of only one image forming apparatus 10 is shown in FIG. 1. The file management server 20 is a server computer that holds and manages a file uploaded from one or more image forming apparatuses 10 via a network 1 in a folder designated as the storage destination. In a cloud service, for example, a system is occasionally constructed to allow overlapping file names. The file management unit may be a server computer that provides such a cloud service.

The image forming apparatus 10 according to the exemplary embodiment names files in accordance with the following rules.

The files to be managed are named for identification from other files. In the exemplary embodiment, the files are provided with serial numbers to be managed. Specifically, a serial number is added to a general file name given each file. That is, serial numbers are added to files having the same name, and thus the files have different names (serial-numbered file names). For example, in the case where a file name “report” is first registered in a predetermined folder, the file is renamed “report_{—}001”. An identifier indicating the type of the file such as “.txt” is not subject to such a name change, and thus is omitted in the description of the exemplary embodiment. In the exemplary embodiment, “report” is referred to a name of a file (which may be referred to simply as “file name”), “001” is referred to as a serial number, and the symbol “_” serving as a separator between the file name and the serial number is referred to as an additional symbol. A file name “report_{—}001” obtained by adding the additional symbol and the serial number to the file name is specifically referred to as a “serial-numbered file name” for discrimination from the file name “report”. In the case where a file name “report” is to be registered if there is a serial-numbered file name “report_{—}001”, the file is given a serial-numbered file name “report_{—}002” with a number (that is, “2”) that follows the maximum serial number value (in the example, “1”). The order of arrangement of the file name and the serial number, the symbol for the additional symbol, and the digit number, if the serial number is expressed in text characters, are not limited to those in the example.

Serial numbers to be included in serial-numbered file names are treated as character strings (text data). Meanwhile, serial numbers are generated as numerical values (binary data). The serial numbers may be converted in terms of data format as necessary. Such a conversion process is omitted in the description of the following processes.

FIG. 2 shows the hardware configuration of the image forming apparatus 10 according to the exemplary embodiment. The image forming apparatus 10 is a multi-function device integrating various functions such as a copy function and a scanner function, and includes a computer (information processing device). In FIG. 2, a CPU 31 controls operation of various mechanisms integrated in the apparatus such as a scanner 34 and a printer engine 36 in accordance with a program stored in a ROM 39. An address data bus 32 is connected to the various mechanisms to be controlled by the CPU 31 for data communication. An operation panel 33 accepts a command from a user, and displays information. The scanner 34 reads a document set by the user, and stores the document in a hard disk drive (HDD) 35 or the like as electronic data. The HDD 35 stores electronic documents etc. read using the scanner 34. The printer engine 36 prints an image on paper for output in accordance with a command from a control program executed by the CPU 31. A network interface 37 is connected to the network 1, and utilized to transmit data on an image read by the scanner 34 and a file saved in the HDD 35, receive an electronic mail transmitted to the apparatus, and allow access to the apparatus by way of a browser. A RAM 38 is utilized as a work memory during execution of a program and as a communication buffer during transmission and reception of electronic data. The ROM 39 stores various programs related to control of the apparatus, encryption of electronic data, and transmission and reception of electronic data. When the various programs are executed, constituent elements to be discussed later demonstrate predetermined processing functions. An external medium interface 40 interfaces with an external memory device such as a USB memory and a flash memory.

The file management server 20 may be implemented by a hardware configuration of a general-purpose server computer including a CPU, a ROM, a RAM, an HDD, an input unit, an output unit, a communication unit, and so forth.

Returning to FIG. 1, the image forming apparatus 10 according to the exemplary embodiment includes an acceptance section 11, a file search section 12, a naming processing section 13, an uploading section 14, a verification processing section 15, a controller 16, and a file holding section 17. Functional blocks that are not necessary for description of the exemplary embodiment are not shown in the drawing. The acceptance section 11 is provided as an acceptance unit. The acceptance section 11 accepts a name of a file set by the user and a folder to store the file. The file search section 12 searches for the folder accepted by the acceptance section 11 on the basis of the file name accepted by the acceptance section 11. The naming processing section 13 is provided as a naming unit. The naming processing section 13 specifies the maximum value of the serial numbers added to the file name accepted by the acceptance section 11, among the files managed by the file management server 20, in the exemplary embodiment among the files stored in the folder accepted by the acceptance section 11, and adds a number that follows the specified maximum value to the file name accepted by the acceptance section 11 to give the file a serial-numbered file name. The uploading section 14 uploads a file to be registered to the file management server 20, and has the file registered under the file name (that is, serial-numbered file name) determined by the naming processing section 13. The verification processing section 15 is provided as a changing unit. The verification processing section 15 verifies whether or not the serial-numbered file name of the file uploaded by the uploading section 14 and registered in the file management server 20 overlaps other file names. In the case where the serial-numbered file name is found to overlap other file names, the serial-numbered file name of the file is changed by updating the numbers included in the overlapping serial-numbered file names in accordance with name changing rules determined in advance. The controller 16 controls execution of processes performed by the constituent elements 11 to 15. The file holding section 17 holds a file to be uploaded to the file management server 20 in advance.

The constituent elements 11 to 16 in the image forming apparatus 10 are implemented through cooperation between a computer integrated in the image forming apparatus 10 and a program that operates on the CPU 31 included in the computer. The file holding section 17 is implemented by the HDD 35 or the RAM 38 integrated in the image forming apparatus 10.

The file management server 20 includes a file management section 21 and a file database 22. Functional blocks that are not necessary for description of the exemplary embodiment are not shown in the drawing. The file database 22 stores files generated by the image forming apparatus 10, classified in designated folders. The file management section 21 registers files in the file database 22 and manages files for readout etc. in response to a request from the image forming apparatus 10. The file management section 21 is implemented through cooperation between a computer and a program that operates on a CPU included in the computer. The file database 22 is implemented by an HDD integrated in the file management server 20.

The programs used in the exemplary embodiment may be not only provided by a communication unit but also provided as stored in a computer-readable recording medium such as a CD-ROM and a DVD-ROM. The programs provided from the communication unit or the recording medium are installed on a computer, and sequentially executed by a CPU of the computer to achieve various processes.

Next, a file registration process according to the exemplary embodiment in which a file held in the image forming apparatus 10 is uploaded to the file management server 20 to be registered will be described with reference to the flowchart shown in FIG. 3.

After the user logs in, the user makes a predetermined screen operation to have a storage destination setting screen displayed on the operation panel 33, and sets a folder as a file uploading destination by selecting a desired folder from a list of folders displayed on the storage destination setting screen or inputting a folder name in a predetermined input field. The list of folders may be acquired from the file management server 20 when the storage destination setting screen is displayed, or may be registered in advance in the image forming apparatus 10.

Further, the user makes a predetermined screen operation to have an upload file setting screen on the operation panel 33, and selects a file to be uploaded from a list of files displayed on the upload file setting screen. The file to be uploaded may also be set by inputting a file name to a predetermined input field. In the description of the exemplary embodiment, the file to be uploaded has been generated by scanning a document and held in the file holding section 17 beforehand. It is a matter of course that the file to be uploaded may be generated in the course of execution of the process.

The acceptance section 11 in the image forming apparatus 10 accepts the name of a folder to store a file to be registered set by the user as described above (step S101), and accepts the name of the file (step S102). Either of steps S101 and S102 may be executed first.

Subsequently, the file search section 12 searches for files with a serial-numbered file name including the file name accepted by the acceptance section 11 stored in the folder accepted by the acceptance section 11 (step S103). For example, if the file name is “report”, the file search section 12 searches for files, the file name of which obtained by excluding the serial number and the additional symbol from the serial-numbered file name is “report”. Then, the naming processing section 13 references the results of the search performed by the file search section 12, and gives the file to be registered a serial-numbered file name generated as follows.

That is, in the case where there are files with a name that is identical to that of the file to be registered (Y in step S104), the naming processing section 13 analyzes the serial-numbered file names of the files to acquire the maximum value of the serial numbers (step S105). Then, the naming processing section 13 determines the serial number to be added to the file to be registered as a number that follows the maximum value, that is, a number obtained by adding 1 to the maximum value (step S106).

In the case where there are no files with a name that is identical to that of the file to be registered (N in step S104), the file with that name is the first to be registered in the folder, and thus the naming processing section 13 determines the serial number to be added to the file as 1 (represented as “001” in text characters) (step S112). When the number to be added to the file name is determined in this way, the naming processing section 13 generates a serial-numbered file name by lining up the file name accepted by the acceptance section 11, the additional symbol, and the determined serial number (step S107).

When the serial-numbered file name for registration in the file management server 20 is determined as described above, the uploading section 14 uploads the file to be registered to the file management server 20, and causes the file management section 21 to store the file in the file database 22 in the folder accepted in step S101 under the file name (serial-numbered file name) determined in step S107 (step S108).

The verification processing section 15 searches the folder accepted by the acceptance section 11 using the serial-numbered file name generated in step S107 to confirm whether or not the same serial-numbered file name has been registered (step S109). If the same serial-numbered file name has not been registered (N in step S110), there are no overlapping files with the serial-numbered file name registered, and thus the process is terminated. If the same serial-numbered file name has been registered (Y in step S110), on the other hand, a serial-numbered file name changing process is performed to avoid overlapping serial-numbered file names (step S111). The serial-numbered file name changing process will be described with reference to the flowchart shown in FIG. 4.

First, the verification processing section 15 specifies the order in which the files with the same serial-numbered file name are registered (step S1111). The order may be specified by referencing the data and time of creation of each file or file identification numbers assigned to the files in accordance with the order of creation.

Subsequently, the verification processing section 15 specifies the order of registration of the file uploaded from the image forming apparatus 10 to which the verification processing section 15 belongs (step S1112). Whether or not a file is uploaded from the image forming apparatus 10 to which the verification processing section 15 belongs may be specified by comparing the owner of the file and the log-in user, for example.

It is assumed that three files have the same serial-numbered file name “A_{—}005”. Intrinsically, the three files should be named “A_{—}005”, “A_{—}006”, and “A_{—}007”. If the three files have been uploaded from the apparatuses A, B, and C (with the apparatus to which the verification processing section 15 belongs being the “apparatus C”), and in the case where the file uploaded from the apparatus C (hereinafter referred to as “own file”) has been registered first (Y in step S1113), the own file should be named “A_{—}005”. Thus, it is not necessary to change the current serial-numbered file name, and the process is terminated.

In the case where the own file has not been registered first (N in step S1113), on the other hand, the verification processing section 15 confirms the order of registration of the own file, and adds a value obtained by subtracting 1 from the order of registration (n-th) to the current number “005” (step S1114). For example, if the own file has been registered second, a value of 1 obtained by subtracting 1 from the order of registration 2 is added. Thus, the serial number for this case is “006”. If the own file has been registered third, a value of 2 obtained by subtracting 1 from the order of registration 3 is added, which results in a serial number of “007”.

When the serial numbers to be changed are determined in this way, the verification processing section 15 generates a serial-numbered file name by lining up the name of the own file, the additional symbol, and the serial number to be changed (step S1115), and gives the own file the generated serial-numbered file name (step S1116).

The serial-numbered file name changing process discussed earlier is performed separately and independently by the image forming apparatuses 10. However, if it is allowed to change the name of (rename) a file registered by other image forming apparatuses 10 with no access restriction or the like, any of the image forming apparatuses 10, for example the image forming apparatus 10 that last registers a file, may representatively change the names of files registered by other image forming apparatuses 10 except for the name of the first registered file.

It is theoretically possible that files with an identical serial-numbered file name are registered in an identical folder during execution of the serial-numbered file name changing process discussed earlier. For example, if an apparatus D attempts to register a file with a file name “A” during execution of the serial-numbered file name changing process for “A_{—}005” discussed earlier, the apparatus D may give the file a serial-numbered file name “A_{—}006”. In this case, such an event is resolved by repeatedly executing steps S109 to S111 until there are no files with an identical serial-numbered file name, that is, until N is taken in the determination performed in step S110.

In the exemplary embodiment, the image forming apparatus 10 gives a serial-numbered file name to a file to be registered in the file management server 20. That is, serial numbers are given to files for each folder and for each file name. However, the present invention may also be applied to a case where files existing in the entire file management system are managed using serial-numbered file names. In this case, for example, the image forming apparatus 10 also searches other image forming apparatuses 10 using a serial-numbered file name in step S103, acquires the maximum value of the serial numbers included in the serial-numbered file names held in each of the other image forming apparatuses 10, and obtains the maximum value of the acquired maximum values. In this way, serial numbers may be added to file names in consideration of the relationship with files that are not registered in the file management server 20.

### Second Embodiment

FIG. 5 shows the overall configuration of a file management system according to an exemplary embodiment and the block configuration of an image forming apparatus 10 and a file management server 20 included in the file management system. FIG. 5 corresponds to FIG. 1 for the first exemplary embodiment. Constituent elements that are the same as those shown in FIG. 1 are denoted by the same reference numerals to omit description thereof as appropriate. The image forming apparatus 10 according to the exemplary embodiment includes a number-specifying file operation section 18 in place of the file search section 12. Providing the number-specifying file operation section 18 eliminates the need for the verification processing section 15. The hardware configuration of the image forming apparatus 10 may be the same as that in the first exemplary embodiment.

The file management server 20 may basically be the same as that in the first exemplary embodiment. The file database 22 is provided as a number-specifying file memory. The file database 22 stores a number-specifying file that specifies the maximum serial number value of the serial numbers added to the names of the files managed by the file management server 20. The number-specifying file is generated for each name of the files, and stored in the corresponding folder.

The number-specifying file operation section 18 in the image forming apparatus 10 is provided as an occupying unit. The number-specifying file operation section 18 occupies a number-specifying file corresponding to the name of the file accepted by the acceptance section 11, among the number-specifying files stored in the file database 22 of the file management server 20. Further, the number-specifying file operation section 18 is provided as a canceling unit. The number-specifying file operation section 18 updates the maximum serial number value specified by the occupied number-specifying file using a number included in the serial-numbered file name by the naming processing section 13, and thereafter cancels the occupied state of the number-specifying file.

In the exemplary embodiment, files with an identical file name are given serial numbers that do not overlap each other utilizing a number-specifying file for serial number management. The number-specifying file may be stored in the file database 22 of the file management server 20 to be acquired and utilized by the image forming apparatus 10, or may be stored and utilized by the image forming apparatus 10.

Next, a file registration process according to the exemplary embodiment in which a file held in the image forming apparatus 10 is uploaded to the file management server 20 to be registered will be described with reference to the flowchart shown in FIG. 6.

The acceptance section 11 accepts the name of a folder to store a file to be registered in the file management server 20 set by the user (step S201), and accepts the name of the file (step S202). The processes may be the same as steps S101 and S102, respectively, in the first exemplary embodiment.

Subsequently, the number-specifying file operation section 18 searches for a number-specifying file for the file name accepted by the acceptance section 11 stored in the folder accepted by the acceptance section 11 (step S203). For example, if the file name is “report”, the number-specifying file operation section 18 searches for a file “report.fileren” with a file type identifier “fileren” indicating a number-specifying file. The identifier “fileren” is merely illustrative, and the present invention is not limited thereto.

In the case where there is a relevant number-specifying file (Y in step S204), the number-specifying file operation section 18 attempts to open the number-specifying file to occupy the number-specifying file. The fact that a folder contains a number-specifying file for a file name suggests that the folder already contains a file with a serial-numbered file name including the file name. In the case where the number-specifying file may not be opened (N in step S205), it is suggested that the number-specifying file is already occupied by another image forming apparatus. Thus, the number-specifying file operation section 18 stands by for about five seconds (step S206), for example, and attempts to open the number-specifying file again. The other image forming apparatus 10 closes the number-specifying file to release the number-specifying file to terminate a file registration process while steps S205 and S206 are repeated. Thus, the apparatus 10 to which the number-specifying file operation section 18 belongs will be able to open the number-specifying file at some time.

That is, if the number-specifying file is opened to be occupied (Y in step S205), the naming processing section 13 acquires the maximum serial number value set to the number-specifying file (step S207). Then, the naming processing section 13 determines the serial number to be added to the file name as a number that follows the maximum value, that is, a number obtained by adding 1 to the maximum value (step S208). In the case where there is no relevant number-specifying file (N in step S204), the file with the name is the first to be registered in the folder, and thus the number-specifying file operation section 18 generates a number-specifying file corresponding to the name of the folder in the folder, and opens the number-specifying file (step S209). Then, the naming processing section 13 determines the serial number to be added to the file as 1 (represented as “001” in text characters) (step S210). When the number to be added to the file name is determined in this way, the naming processing section 13 generates a serial-numbered file name by lining up the file name accepted by the acceptance section 11, the additional symbol, and the determined serial number (step S211).

When the serial-numbered file name for registration in the file management server 20 is determined as described above, the uploading section 14 uploads the file to be registered to the file management server 20, and causes the file management section 21 to store the file in the file database 22 in the folder accepted in step S201 under the file name (serial-numbered file name) determined in step S211 (step S212).

Subsequently, the number-specifying file operation section 18 updates the number-specifying file by writing the number determined in step S208 into the number-specifying file (step S213), and cancels the occupied state by closing the number-specifying file (step S214).

In the exemplary embodiment, as has been described above, a number-specifying file prepared for each folder and for each file name is used so that file names with an identical serial number are not generated. That is, the number-specifying file is opened to be occupied in prior to a naming process for giving serial-numbered file names so that the naming process is executed exclusively. Thus, it is not necessary to perform a verification process as in the first exemplary embodiment. Thus, the naming process may be exclusively executed by a method other than opening a file, for example using a flag indicating that the naming process is being executed.

In the exemplary embodiment, the maximum serial number value is written into the number-specifying file provided in correspondence with a file name in order to specify the maximum serial number value added to the file name. However, the present invention is not limited thereto. For example, the file name of the number-specifying file may be generated by adding the maximum serial number value to the file name as with a serial-numbered file name.

In the exemplary embodiment, serial numbers are given for each folder and for each file name, and thus the number-specifying file is provided in the corresponding folder. If the number-specifying file is provided with information specifying a folder such as a folder name, however, it is not necessary to provide the number-specifying file in the corresponding folder.

In the description of the exemplary embodiments discussed earlier, the image forming apparatus 10 is provided as an example of the information processing device. However, the information processing device may be implemented by a general-purpose computer such as a personal computer (PC).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
an acceptance unit that accepts a name of a file;
a specification unit that specifies a maximum value of serial numbers added to the name of the file accepted by the acceptance unit, among files managed by a file management unit that manages the files; and
a naming unit that gives a serial-numbered file name to the file accepted by the acceptance unit by adding a number that follows the maximum value specified by the specification unit to the name of the file.

2. The information processing device according to claim 1, further comprising:
a changing unit that if the serial-numbered file names given by the naming unit to the files managed by the file management unit are found to overlap each other, updates a number included in the overlapping serial-numbered file names in accordance with name changing rules determined in advance to change the serial-numbered file name of the file.

3. The information processing device according to claim 1,
wherein the specification unit further includes an occupying unit that occupies a number-specifying file corresponding to the name of the file accepted by the acceptance unit, among number-specifying files that specify a maximum serial number value of serial numbers added to names of the files managed by the file management unit, the number-specifying files being stored in a number-specifying file memory that stores the number-specifying files generated for each of the names of the files,
the naming unit gives a serial-numbered file name to the file accepted by the acceptance unit by adding a number that follows the maximum serial number value specified by the number-specifying file occupied by the occupying unit to the name of the file, and
the information processing device further includes a canceling unit that updates the maximum serial number value specified by the number-specifying file occupied by the occupying unit using a number included in the serial-numbered file name determined by the naming unit, and that thereafter cancels an occupied state of the number-specifying file.

4. The information processing device according to claim 3,
wherein the occupying unit generates a number-specifying file corresponding to the name of the file accepted by the acceptance unit in the number-specifying file memory to occupy the number-specifying file in the case where no such number-specifying file is stored in the number-specifying file memory.

5. A non-transitory computer readable medium storing a program causing a computer to function as:
an acceptance unit that accepts a name of a file;
a specification unit that specifies a maximum value of serial numbers added to the name of the file accepted by the acceptance unit, among files managed by a file management unit that manages the files; and
a naming unit that gives a serial-numbered file name to the file accepted by the acceptance unit by adding a number that follows the maximum value specified by the specification unit to the name of the file.

6. A file management system comprising:
at least one information processing device; and
a file management server that manages files with an identical file name using serial-numbered file names determined by adding a serial number to a name of a file,
wherein the information processing device includes:
an acceptance unit that accepts a name of a file;
a unit that specifies a maximum value of serial numbers added to the name of the file accepted by the acceptance unit, among files managed by the file management unit; and
a naming unit that gives a serial-numbered file name to the file accepted by the acceptance unit by adding a number that follows the specified maximum value to the name of the file.
